(19) United States
(12) Patent Application Publication
(10) Pub. No.: US 2006/0026800 A1
(43) Pub. Date: Feb. 9, 2006

(54) Pry bar ergonomic handle

(76) Inventor: John C. Lawless, Charlemont, MA (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/247,299

(22) Filed: Oct. 11, 2005

Related U.S. Application Data
(63) Continuation-in-part of application No. 10/429,463, filed on May 5, 2003.

(51) Int. Cl. B25G 1/10

(52) U.S. Cl. 16/430

(57) ABSTRACT

A heavy duty hand tool handle has specifically configured thermoplastic and overmolded elastomeric material, with a thermoplastic grip and thumb receiving recesses for equal right and left hand ergonomic use. Metal indicia are forcibly embedded in the thermoplastic case to provide e.g. safety information which remains legible in long term heavy duty abrasive use.

### PRIOR RELATED APPLICATIONS

This application is a continuation-in-part of U.S. Ser. No. 10/429,463, filed May 5, 2003, now U.S. Pat. No. ______.

### BACKGROUND OF THE INVENTION

1. Field of the Invention

This invention relates to hand tool handles. Specifically, this invention relates to hand tool ergonomic handles, particularly including heavy duty use hand tool handles, and more particularly pry bar handles.

2. Background and Discussion of the Prior Art

In general, heavy duty hand tools such as pry bars and wrecking tools are of all metal construction and are cumbersome to grip and use. Often the user has to grip a rectilinear metal portion of the hand tool in use. One such prior art construction is disclosed in U.S. Pat. No. 6,058,809 to Flanz. A wrecking tool is disclosed in U.S. Patent Application Publication No. 2002/0134971 to Christensen. The Christensen heavy duty wrecking tool has an elongated octagonal cross-sectional metal handle or bar stock portion. A non-octagonal handgrip is slidably attached to the octagonal metal bar.

It is generally known to provide a soft elastomeric molded over cover on a molded hard thermoplastic core for improved grip for knives, screwdrivers, and like bladed tools. Such prior art constructions are disclosed in Sanelli, U.S. Pat. No. 4,712,304; Gakhar, U.S. Pat. No. 5,390,572; Hoepfl, U.S. Pat. No. 5,964,009; and Panaccione, U.S. Pat. No. 5,956,799. Generally these handles do not provide sufficient ergonomic character and do not sufficiently accommodate both right and left handed use.

U.S. Pat. No. 6,471,186 and U.S. Pat. No. 6,772,994 granted to Lawless the inventor herein, which Lawless patents are commonly owned with the present application, disclose improvements wherein a metal end cap and pry bar shank are molded into a unitary thermoplastic core, and an elastomeric material is over-molded on the thermoplastic core. A ribbed elastomeric surface was provided in the radially extending distally disposed flange for finger engagement.

Handles that undergo heavy duty or industrial use consequently undergo considerable wear, particularly frictional wear. Where such handles are conventionally imprinted with indicia, the printed indicia would in time wear away and become less legible or illegible. This wear impediment was particularly prevalent in heavy duty tool handles, particularly pry bar handles. Such heavy duty tool handles often require government regulatory safety notices to be imprinted on the handles and remain legible throughout the useful life of the tool.

The hand tool art desires a handle that had long term wear resistant indicia.

The hand tool art also desires an improved ergonomic grip heavy duty handle, particularly with improved ergonomic characteristics equally for both right and left handed users.

It is therefore a principal object of the present invention to provide an ergonomic handle and hand tool.

It is another principal object of the present invention to provide an improved grip hand tool handle having heavy duty wear resistant indicia.

It is another object of the present invention to provide an improved ergonomic handle for a heavy duty hand tool as aforesaid that provides equal ergonomic characteristics for both right and left handed users.

It is still another object the present invention to provide a hand tool handle as aforesaid with diverse functionality.

It is another object of the present invention to provide a hand tool handle as aforesaid for heavy duty pry bar use.

It is still a further object of the present invention to provide a hand tool as aforesaid which is practical in design, manufacture and use.

### SUMMARY OF THE INVENTION

A handle for a heavy duty hand tool, such as a pry bar, is formed of a hard thermoplastic core and a soft elastomeric cover integrally bonded to the hard thermoplastic core and partially covering the core. The selectively uncovered portions of the handle core provide ergonomically effective surfaces and permanent indicia bearing surfaces. A plurality of thermoplastic grip surfaces and a plurality of thermoplastic thumb engaging recesses are formed of the core thermoplastic, and are specifically disposed to provide equal ergonomic characteristics for both right and left handed use. Metal sheet material is forcibly embedded in at least one of the elongated thermoplastic grip surfaces, whereby the embedded metal indicia retains its readability with extended heavy duty use. The embedded indicia provides product information and regulatory safety information. A metal impact cap is fixedly disposed in the handle core proximate end and is in co-molded facing disposition to the pry bar blade, to provide complementary heavy duty impact functionality.

### BRIEF DESCRIPTION OF THE DRAWINGS

FIG. 1 is a perspective view of the pry bar of present invention;

FIG. 2 is a top plain view of the pry bar of FIG. 1;

FIG. 3 is a sectional view taken along line 3-3 of FIG. 2;

FIG. 4 is an enlarged sectional view taken along line 4-4 of FIG. 2;

FIG. 5 is an enlarged sectional view taken along line 5-5 of FIG. 2;

FIG. 6 is a side elevated view of the pry bar of FIG. 1;

FIG. 7 is a sectional view taken along line 7-7 of FIG. 6;

FIG. 8 is a bottom view of the pry bar of FIG. 1;

FIG. 9 is a greatly enlarged fragmentary sectional view taken along 9-9 of FIG. 2;

FIG. 10 is a greatly enlarged fragmentary sectional view taken along line 10-10 of FIG. 2; and

FIG. 11 is a greatly enlarged fragmentary sectional view taken along line 11-11 of FIG. 8.

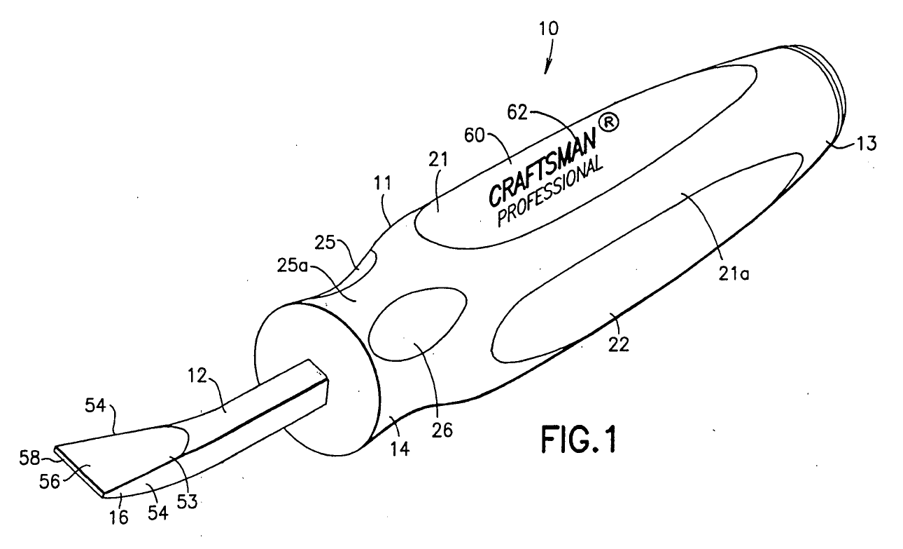

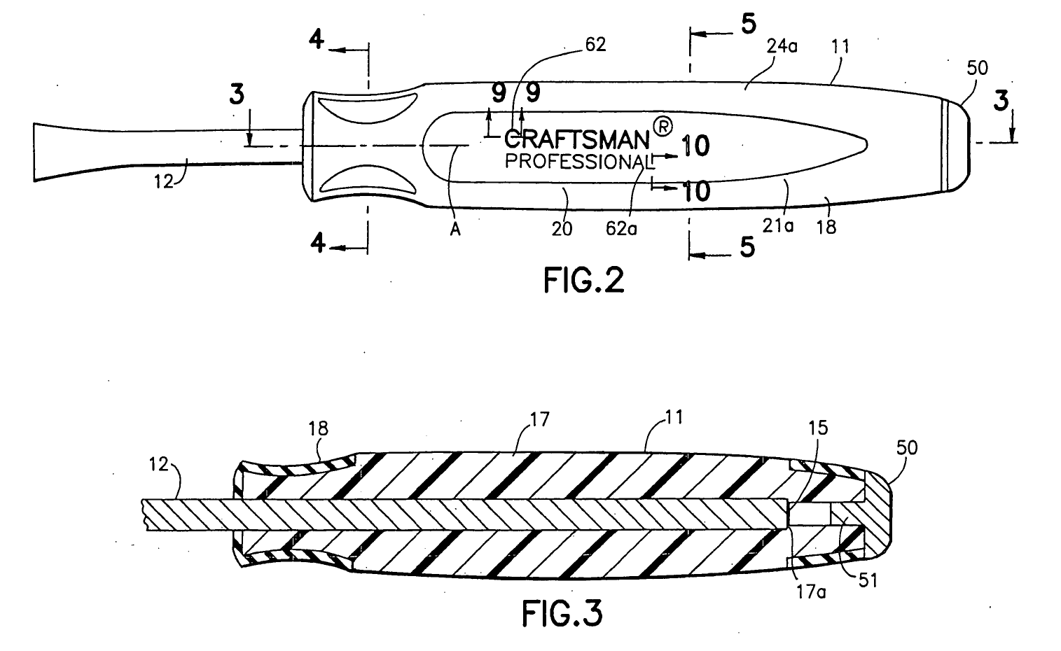

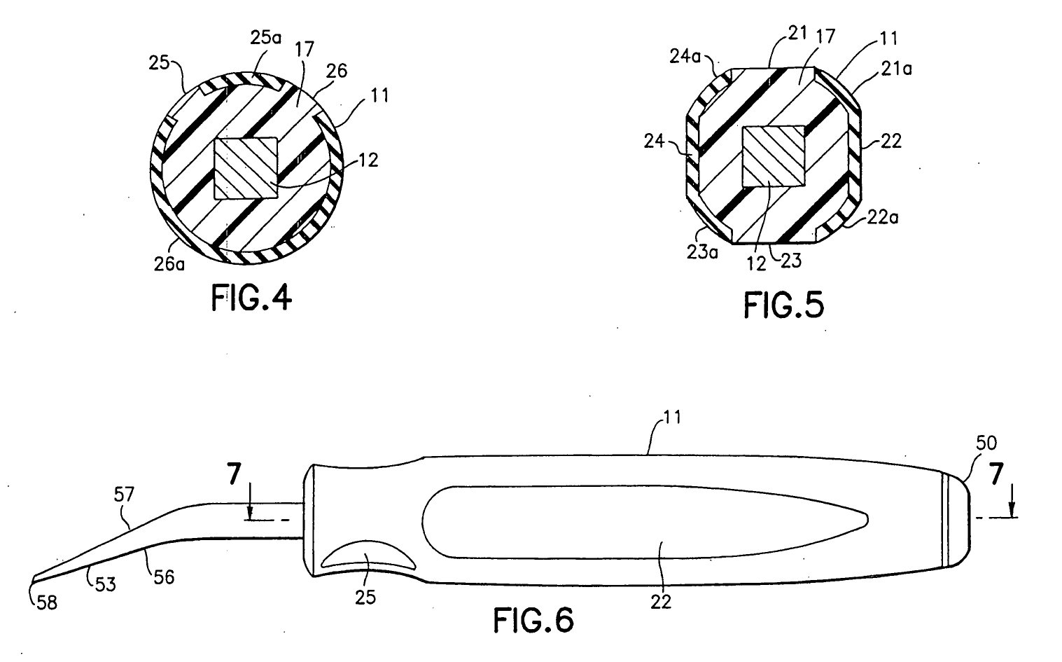

### DESCRIPTION OF THE PREFERRED EMBODIMENTS

Referring to the FIGS., there is shown pry bar 10 having handle 11 and a proximate end 13 and a distal end 14, and a blade or shank 12. Blade 12 is of generally rectilinear sectional construction and has a proximate end 15 and a distal end 16. Handle 11 is formed of a hard thermoplastic molded core 17 and a molded over integrally bonded elastomeric cover 18. Cover 18 is formed of relatively soft elastomeric material.

The proximate end 15 of blade 12 is securely fixedly molded in core 17, with the formation of core 17 as at 17a, by means known in the art. The elastomeric cover 18 is then integrally molded over and bonded to the core by means well known in the knife, screwdriver, and like bladed hand tool handle prior art. Certain specifically contoured designed portions of the core are left uncovered, for purposes hereinafter appearing.

Handle 11 has grip surface or 20 has two proximately tapered elongated hard thermoplastic planar top and bottom grip portions 21 and 23 two proximately tapered planar elastomeric side grip portions 22 and 24 four contoured elastomeric corner surfaces 21a, 22a, 23a, and 24a, and two spacedly disposed oval hard thermoplastic thumb recesses 25 and 26. Recesses 25 and 26 are disposed on opposite sides of and equally spaced from adjacent handle centerline A of grip portion 20, for purposes hereinafter appears. The oval recesses are surrounded by elastomeric portions 25a and 26a. The oval recesses importantly in combination with the other grip portions provides improved ergonomic characteristics for both right and left hand use.

Grip portions 21 and 23 are permanently imprinted with metal (e.g. gold) indicia 60 and 61 respectively. Metallic indicia 60 and 61 are formed from a metal sheet or foil A drive or stamping platen (not shown) drives the metal foil under high pressure into the hard thermoplastic surfaces 21 and 23.

It has been found that by applying heat and more particularly high pressure to a metal foil, indicia such as a trademark 62, product information 62a and regulatory safety information 63, 63a can be permanently embedded into the hand tool handle. The embedded indicia is found to be highly wear resistant. The embedded or imprinted indicia was found to withstand the high pressure sandblast wear resistance test, namely ASTM D968—Method A, which ASTM test standard is incorporated herein by reference thereto. This ASTM test standard involves high pressure, high volume sandblasting. The selected metal indicia may exhibit greater abrasion resistance than the adjacent hard thermoplastic material. It is known in the art to embed or imprint gold leaf or foil under heat and pressure onto a hard thermoplastic surface. Methods for imprinting or embedding gold leaf in transfer foils on hard thermoplastic surfaces are described in U.S. Pat. No. 4,275,116, granted Jun. 23, 1981 to Kratschmer; U.S. Pat. No. 5,827,603, granted Oct. 27, 1998 to Suss; U.S. Pat. No. 5,980,679, granted Nov. 9, 1999 to Severin et al; U.S. 2004/0144479, published Jul. 29, 1004 to Cuel; and U.S. Pat. No. 6,280,823 granted Aug. 28, 1001 to Preisler et al; which references are incorporated herein by reference thereto.

Referring specifically to FIGS. 9-11, there is shown metal indicia, 60, 61, 62, 62a, 63, 63a embedded in thermoplastic surfaces 21 and 23. The embedded metal is disposed at or extending slightly from thermoplastic surfaces. The embedded or height of the metal is about the same as the face or height of the adjacent elastomeric surface. In heavy duty use, the metal may undergo some abrasive loss, but importantly the of the metal is retained and indicia remains legible.

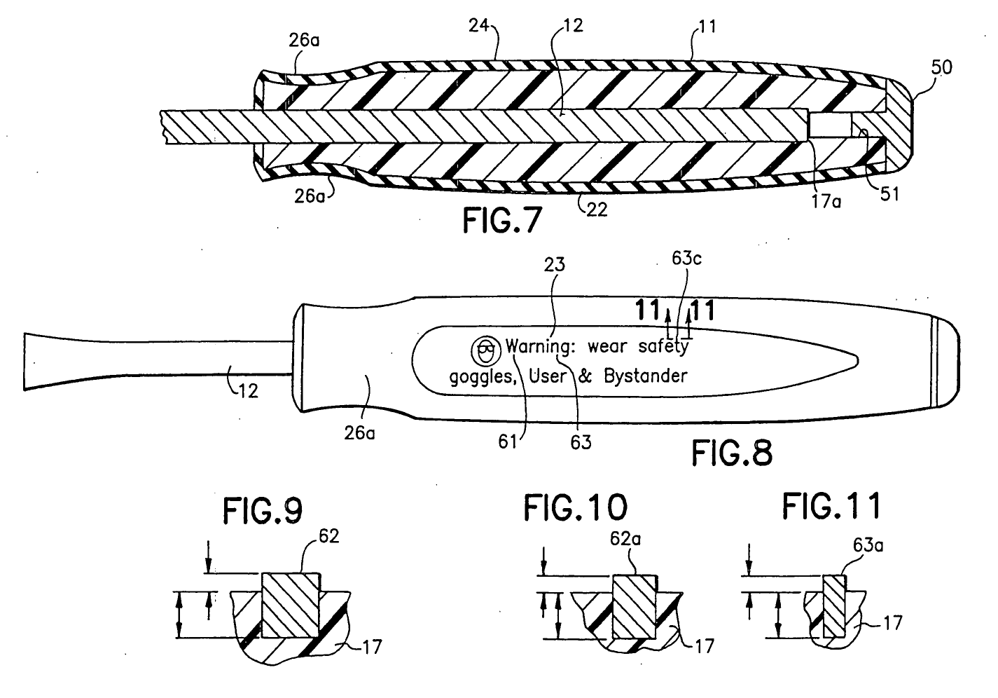

A metal impact cap 50 is fixedly disposed at the proximate end 13 of the handle 11. Cap 50 has a prong 51 which is fixedly secured and molded within the handle core 17, as best shown in FIGS. 3 and 7. Cap 50 is used by way of example to impact screw heads prior to screw driving same. Metal cap 50 in handle 11 is constructed for heavy impact operations.

Blade 12 is of square or rectilinear cross-sectional metal construction. Blade 12 has a proximate end 15 and a distal end 16. Proximate end 15 is molded in situ with the formation core 17, so as to be fixedly secured within handle 11, by means well known in the art. Blade distal end 16 is formed with a pry end 53. Pry end 53 has outwardly tapered sides 54, and upper and lower surfaces 56 and 57. Surfaces 56 and 57 are distally tapered, and extend towards sharpened edge or tip 58. Tip 58 is upwardly angularly disposed with respect to blade 12. Blade 12 is fixedly disposed in handle 11 distal end 14.

In the aforesaid manner of construction, there is provided an ergonomic hand tool and handle. More specifically, elongated distally tapered grip surfaces 21-24 and specifically the alternate hard and soft elongated tapered surface in combination with contoured elastomeric corners 21a-24a, and the specifically positioned spacedly disposed alternate thumb engaging recesses 25-26 provide alternate right or left handed user ergonomic grips. That is, the user has equal right and left hand ergonomic effects. And regardless of the hand used, the handle provides comfort and reduced fatigue and particularly as compared with conventional heavy duty use hand-tools.

The core may be preferably formed of a hard thermoplastic material and the cover may be formed of a right elastomeric material as are well known in the hand tool handle art.

The afore-discussed handle surfaces and contours, and in conjunction with the hand tool configuration and disposition with respect to the handle, provides an equal left and right hand ergonomic grip hand tool.

While the foregoing describes certain embodiments of the invention, various modifications and changes may be made within the spirit and scope of the invention, as defined by the adjoined claims.

What is claimed is:

1. A pry bar comprising:
a handle having a distal end and a proximate end;
a grip portion disposed between the distal end and the proximate end, said grip portion comprising a thermoplastic portion and an elastomeric portion;
two of thumb receiving recesses being formed in the thermoplastic core disposed between the handle grip portion and the handle distal end;
a blade, said blade having a proximate end and a distal end, said blade proximate end being secured within said handle distal end, said blade being elongate, said blade distal end being formed with a pry end, said pry end being in angular disposition.

2. The pry bar of claim 1, said elastomeric portion partially covering said thermoplastic core so as to form the thermoplastic grip portion and the thermoplastic thumb recesses.

3. The pry bar of claim 1, further comprising material embedded in the thermoplastic grip portion, said material comprising indicia, whereby the indicia remains legible with extended heavy duty use of the pry bar.

4. The hand tool of claim 3, said material comprising a metallic appearance.

5. The hand tool of claim 4, said metallic appearance comprising a gold appearance.

6. The hand tool of claim 3, said material comprising a metal.

7. The pry bar of claim 1, further comprising a metal impact cap fixedly disposed at the proximate end.

8. The handle of claim 1, said handle having oppositely disposed top and bottom thermoplastic grip portions, each thermoplastic grip portion comprising metallic indicia embedded in the top and bottom thermoplastic grip portions.

9. The hand tool of claim 8, further comprising a metal impact cap fixedly disposed in the handle proximate end.

10. A hand tool comprising:
a handle formed of a thermoplastic material core and a elastomeric material, partially covering the core; the handle having a distal end and a proximate end;
a plurality of elongated grip surfaces comprising said thermoplastic material; and
two thumb receiving recesses comprising said thermoplastic material; said thumb receiving recesses being distally disposed from said elongated grip surfaces.

11. The hand tool of claim 10, at least one said elongated grip surface comprises a center line, said thumb receiving recesses being disposed on opposite sides of the center line, whereby there is alternate right or left handed ergonomic grip of the handle.

12. The hand tool of claim 10, said elastomeric material surrounds said thermoplastic grip surfaces and said thermoplastic thumb receiving recesses.

13. The hand tool of claim 10, said at least one elongated grip surface comprising a proximate edge and a distal edge, said thumb receiving recesses each comprising a proximate edge and a distal edge, said thumb receiving recess proximate edges are adjacent to the elongated grip surface distal edge.

14. The hand tool of claim 10, further comprising metallic indicia embedded in at least one of the elongated thermoplastic material grip surfaces, whereby the indicia is readable in extended heavy duty use of the hand tool.

15. The hand tool of claim 11, said indicia retains legibility when subject to sandblast test ASTM D968, Method A.

16. The hand tool of claim 15, said metallic indicia extends into the thermoplastic grip surface.

17. The hand tool of claim 10, further comprising a metal impact cap fixedly disposed in the proximate end of the hand tool.

18. The hand tool of claim 17, said elastomeric material being disposed immediately adjacent to the metal impact cap.

19. The hand tool of claim 17, said thermoplastic core being formed with a through core and said metal impact cap and said blade proximate end being fixedly disposed in the core and in facing disposition.

20. The hand tool of claim 10, said elongated thermoplastic grip surface comprising a tapered proximately disposed edge.

21. A tool handle comprising;
a thermoplastic core being formed with a central hole for receiving a shank;
an elastromeric covering formed on the thermoplastic core; Indicia forming material disposed within the thermoplastic core; wherein the indicia is legible by the user after being subjected ASTM D968, Method A.

22. The tool handle of claim 21, whereby the indicia remains readable after the handle is subjected to sandblasting under pressure.

23. The tool handle of claim 21, wherein the indicia forming materials extend outwardly from the thermoplastic core to a height about equal to the height of the elastomeric material adjacent to the readable indicia material.

24. The tool handle of claim 21, said handle being a distal end and a proximate end said central handle comprising a through hold extending for the distal end to proximate end, and further comprising an impact cap disposed in the through hole adjacent to the proximate end of the handle, and said shank being disposed at distal end.

25. The tool handle of claim 24, said shank comprising a pry bar distal end.

26. The tool handle of claim 21, said handle having an upper surface and a lower surface, said elastomeric material reliably covering the thermoplastic upper surface and lower surface.

27. The tool handle of claim 16 said indicia forming material comprises a metal fixedly disposed in the thermoplastic surface and wherein the metal indicia meets wearability test of ASTM D968, Method A, so that the indicia is legible after being subjected to said test.

28. The tool handle of claim 27, said upper surface indicia comprises product information, and said lower surface indicia comprises safety information.

29. The tool handle of claim 21, said handle having an upper surface and a lower surface, said upper surface comprising thermoplastic right and left thumb receiving recesses disposed adjacent to the distal end of the handle.

30. The tool handle of claim 21, said handle lower surface comprising an elastomeric material under finger receiving surface.

31. The tool handle of claim 20 said indicia material comprises a metallized material.

32. The tool handle of claim 31, said indicia having an abrasion resistance greater than said thermoplastic material.
